(19) United States
(12) Patent Application Publication
(10) Pub. No.: US 2010/0073418 A1
(43) Pub. Date: Mar. 25, 2010

(54) HEAD CAP AND IMAGE RECORDING APPARATUS

(75) Inventor: Yasunori KOBAYASHI, Gifu-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/494,162

(22) Filed: Jun. 29, 2009

(30) Foreign Application Priority Data
Sep. 19, 2008 (JP) 2008-240665

(51) Int. Cl. B41J 2/165

(52) U.S. Cl. 347/29

(57) ABSTRACT

A head cap, including: a bottom plate portion having a bottom surface facing a liquid-droplets ejecting surface of a liquid-droplets ejecting head; a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area; and an inner plate which is disposed along the projecting portion so as to cover an inner wall surface of the projecting portion.

### CROSS REFERENCE TO RELATED APPLICATION

The present application claims priority from Japanese Patent Application No. 2008-240665, which was filed on Sep. 19, 2008, the disclosure of which is herein incorporated by reference in its entirety.

### BACKGROUND OF THE INVENTION

1. Field of the Invention

The present invention relates to a head cap which covers or caps a liquid-droplets ejecting surface of a liquid-droplets ejecting head configured to eject liquid droplets, and relates to an image recording apparatus including the head cap.

2. Description of the Related Art

Patent Document 1 (U.S. Pat. No. 6,866,361 B2 corresponding to JP-A-2004-142450) discloses an ink-jet recording apparatus including ink-jet heads and a maintenance unit which performs a maintenance of the ink-jet heads. In this ink-jet recording apparatus, the maintenance unit includes caps each formed of an elastic material such as rubber for covering or capping a nozzle surface (an ink-ejection surface) of the corresponding ink-jet head. Each cap covers the nozzle surface, thereby preventing drying of an ink in nozzles.

### SUMMARY OF THE INVENTION

According to the ink-jet recording apparatus disclosed in the above-described Patent Document 1, a projection defining a recessed portion is formed on each cap, and the projection is brought into contact with the nozzle surface such that the nozzle surface of the ink-jet head is covered with the cap defining the recessed portion. The projection of the cap has flexibility in order to assure airtightness in the cap at proper pressure without scratches or blemishes made on the nozzle surface. Thus, a portion of the projection may be deformed and fall or tip when an uneven pressure is applied to the projection of the cap from the nozzle surface by inclination of the cap or the nozzle surface. In this case, since the airtightness in the cap lowers, drying of the ink in the nozzles cannot be prevented. Further, an unnecessary ink adhering to a portion between the nozzle surface and the projection having fallen to an inside of the cap contacts with openings of the respective nozzles, whereby ink ejection failure may arise, or a liquid-repellent film may be damaged or scratched.

This invention has been developed in view of the above-described situations, and it is an object of the present invention to provide a head cap which can prevent a projecting portion that contacts with a liquid-droplets ejecting surface from falling.

The object indicated above may be achieved according to the present invention which provides a head cap, comprising: a bottom plate portion having a bottom surface facing a liquid-droplets ejecting surface of a liquid-droplets ejecting head; a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area; and an inner plate which is disposed along the projecting portion so as to cover an inner wall surface of the projecting portion.

The object indicated above may also be achieved according to the present invention which provides an image recording apparatus, comprising: a liquid-droplets ejecting head including a liquid-droplets ejecting surface in which a liquid-droplets ejecting area is formed; and a head cap including (a) a bottom plate portion having a bottom surface facing the liquid-droplets ejecting surface of the liquid-droplets ejecting head and (b) a projecting portion which functions as a side wall, which extends from the bottom plate portion so as to define a recessed portion with the bottom plate portion, and whose distal end contacts with a surrounding of the liquid-droplets ejecting area formed in the liquid-droplets ejecting surface so as to enclose the liquid-droplets ejecting area, wherein the head cap further includes an inner plate which is disposed along the projecting portion so as to cover an inner wall surface of the projecting portion.

According to the head cap and the ink-jet printer to each of which the present invention is applied, since the inner plate is disposed along the projecting portion, the projecting portion can be prevented from falling when the circular portion is brought into contact with the liquid-droplets ejecting surface.

### BRIEF DESCRIPTION OF THE DRAWINGS

The objects, features, advantages, and technical and industrial significance of the present invention will be better understood by reading the following detailed description of a preferred embodiment of the invention, when considered in connection with the accompanying drawings, in which:

FIG. 1 is a side elevational view in cross section generally showing an ink-jet printer as an embodiment of the present invention;

FIG. 2 is a plan view generally showing a main portion of the ink-jet printer shown in FIG. 1;

FIG. 3 is a cross-sectional view taken along line III-III of FIG. 2;

FIG. 4 is a view of four ink-jet heads shown in FIG. 2 as seen from below;

FIG. 5A is a plan view of one of caps shown in FIG. 2, and FIG. 5B is a cross-sectional view of the cap;

FIG. 6 is a cross-sectional view taken along line VI-VI of FIG. 5;

FIG. 7 is a view showing a case in which a circular projection of the cap shown in FIG. 5 and the ink-ejection surface contact with each other;

FIG. 8A is a view showing a case in which one of the ink-jet heads shown in FIG. 2 is moved from a “print position” to a “head maintenance position” while a tray of a maintenance unit is moved to a “maintenance position”, and FIG. 8B is a view showing a case in which an ink adhering to the ink-ejection surface is being wiped by a wiper shown in FIG. 2; and

FIG. 9 is a cross-sectional view of one of caps according to a modification of the embodiment of the present invention.

### DESCRIPTION OF THE PREFERRED EMBODIMENT

Hereinafter, there will be described a preferred embodiment of the present invention by reference to the drawings.

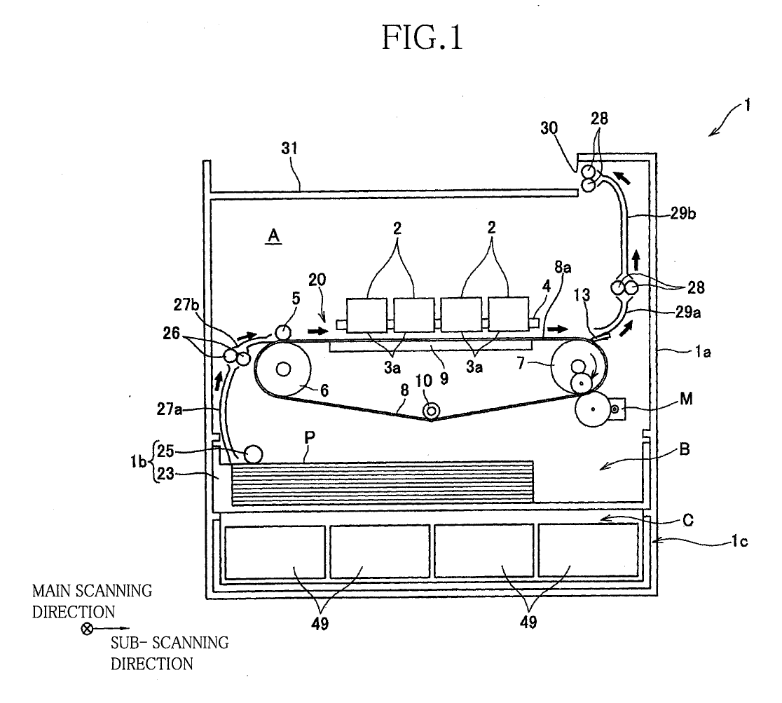

As shown in FIGS. 1-3, an ink-jet printer 1 includes a body 1a having a rectangular parallelepiped shape. A sheet-discharge portion 31 is provided at an upper portion of the body 1a. Further, an inside of the body 1a is separated into three spaces A, B, C in order from above. In the space A, there are disposed four ink-jet heads (i.e., liquid-droplets ejecting heads) 2 which respectively eject inks of four colors, namely, magenta, cyan, yellow, and black, a sheet-feed unit 20, and a maintenance unit 70 (on a back side of the sheet-feed unit 20 in FIG. 1). The spaces B, C are spaces in which a sheet-supply unit 1b and an ink tank unit 1c attachable and detachable to and from the body 1a are respectively disposed. It is noted that, in the present embodiment, a sub-scanning direction is a direction parallel to a sheet feeding direction in which each sheet P is fed by the sheet-feed unit 20 while a main scanning direction is a direction perpendicular to the sub-scanning direction and along a horizontal surface.

In the ink-jet printer 1, there is formed a sheet feeding path (indicated by boldface arrow in FIG. 1) in which each sheet P is fed from the sheet-supply unit 1b to the sheet-discharge portion 31. The sheet-supply unit 1b includes a sheet-supply tray 23 which can accommodate a plurality of the sheets P, and a sheet-supply roller 25 attached to the sheet-supply tray 23. The sheet-supply roller 25 supplies or feeds an uppermost one of the sheets P stacked on each other and accommodated in the sheet-supply tray 23. The sheet P supplied by the sheet-supply roller 25 is fed to the sheet-feed unit 20 while being guided by guides 27a, 27b and being nipped between a pair of feed rollers 26.

The sheet-feed unit 20 includes two belt rollers 6, 7, an endless sheet-feed belt 8 wound around the rollers 6, 7 so as to bridge the rollers 6, 7, and a tension roller 10. The tension roller 10 applies tension to the sheet-feed belt 8 by being biased downward while contacting with an inner peripheral surface of the sheet-feed belt 8 at a lower portion of the belt 8. A belt roller 7 is a drive roller rotated in a clockwise direction in FIG. 1 by being given a drive force from a sheet feeding motor M via two gears. The belt roller 6 is a driven roller rotated in the clockwise direction in FIG. 1 with rotation of the sheet-feed belt 8 by rotation of the belt roller 7.

An outer peripheral surface 8a of the sheet-feed belt 8 is subjected to a silicone treatment to have a viscosity. In the sheet feeding path, there is disposed a nipping roller 5 at a position opposite to the belt roller 6 in a state in which the sheet-feed belt 8 is interposed between the nipping roller 5 and the belt roller 6. The nipping roller 5 presses, toward the outer peripheral surface 8a of the sheet-feed belt 8, each sheet P supplied by the sheet-supply unit 1b. The sheet P pressed toward the outer peripheral surface 8a is fed rightward in FIG. 1 while being held by and on the outer peripheral surface 8a owing to the viscosity thereof.

A peeling plate 13 is provided in the sheet feeding path at a position opposite to the belt roller 7 in a state in which the sheet-feed belt 8 is interposed between the peeling plate 13 and the belt roller 7. The peeling plate 13 peels, from the outer peripheral surface 8a, each sheet P held by the outer peripheral surface 8a of the sheet-feed belt 8. The sheet P peeled by the peeling plate 13 is fed while being guided by guides 29a, 29b and being nipped between two pairs of feed rollers 28. Then, the sheet P is discharged to the sheet-discharge portion 31 from an opening 30 formed in an upper portion of the body 1a.

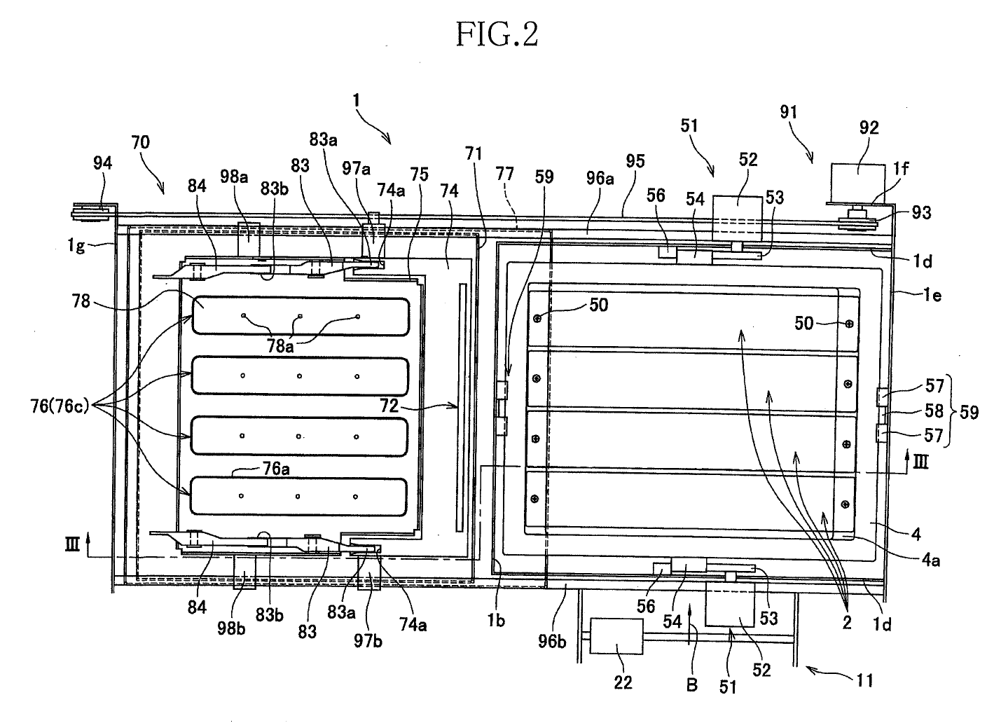

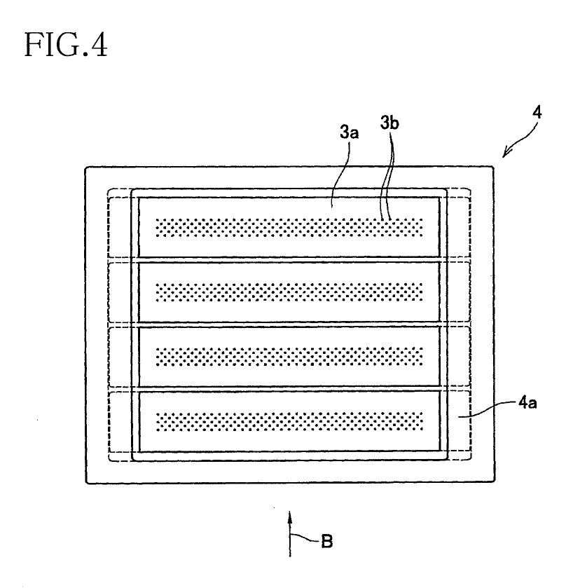

As shown in FIGS. 2-4, each of the four ink-jet heads 2 extends in the main scanning direction and is fixed to a frame 4 in a state in which the heads 2 are arranged adjacent to each other in a sheet feeding direction B. The frame 4 includes supporting portions 4a projected to positions respectively facing opposite end portions of a lower surface of the ink-jet head 2 in a longitudinal direction thereof. The supporting portions 4a and the respective opposite end portions of the ink-jet head 2 are fixed by screws 50. Further, as shown in FIG. 4, in an ink-ejection surface (i.e., a liquid-droplets ejecting surface) 3a of each ink-jet head 2, there are formed a plurality of nozzles 3b in the main scanning direction (i.e., the longitudinal direction of the ink-jet head 2). A direction in which the nozzles 3b are arranged in rows (i.e., a direction of rows of the nozzles) coincides with a longitudinal direction of caps 76 which will be described below. It is noted that an area of each ink-ejection surface 3a in which the nozzles 3b are formed functions as an ink-ejection area (i.e., a liquid-droplets ejecting area) of the ink-ejection surface 3a. Thus, the ink-jet printer 1 is a color ink-jet printer of a line type in which the ink-ejection area extending in the main scanning direction is formed.

As shown in FIG. 1, a platen 9 is disposed in a loop of the sheet-feed belt 8 so as to be opposed to the four ink-jet heads 2. An upper surface of the platen 9 contacts with the inner peripheral surface of the upper portion of the sheet-feed belt 8 and supports the sheet-feed belt 8 from a side of the inner peripheral surface thereof. As a result, the outer peripheral surface 8a of the upper portion of the sheet-feed belt 8 and the respective lower surfaces of the ink-jet heads 2, i.e., the ink-ejection surfaces 3a are opposed and parallel to each other, and a slight space is formed between the ink-ejection surfaces 3a and the outer peripheral surface 8a of the sheet-feed belt 8. The space partly constitutes the sheet feeding path. When each sheet P fed while being held by the outer peripheral surface 8a of the sheet-feed belt 8 is fed through just below the four ink-jet heads 2, the inks of the respective colors are sequentially ejected onto an upper surface of the sheet P from the ink-jet heads 2, thereby forming a desired color image on the sheet P.

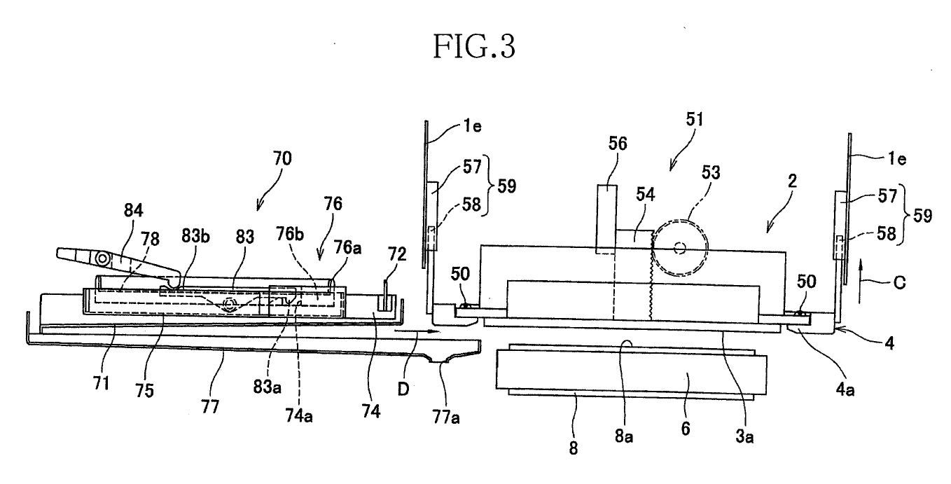

Further, as shown in FIGS. 2 and 3, the frame 4 is supported by frame moving mechanisms 51 provided in the ink-jet printer 1 so as to be movable upward and downward. The frame moving mechanisms 51 are disposed on outer sides of the four ink-jet heads 2 (i.e., an upper side and a lower side in FIG. 2). Each of the frame moving mechanisms 51 includes a drive motor 52, a pinion gear 53, a rack gear 54, and a guide 56. The drive motor 52 functions as a drive source which moves the frame 4 upward and downward. The pinion gear 53 is fixed to a shaft of the drive motor 52. The rack gear 54 is provided and stands on the frame 4 so as to be meshed with the pinion gear 53. The guide 56 is disposed at a position in which the guide 56 interposes the rack gear 54 with the pinion gear 53, that is, the guide 56 is disposed such that the rack gear 54 is interposed between the guide 56 and the pinion gear 53.

The two drive motors 52 are respectively fixed to main body frames 1d of the ink-jet printer 1 and disposed so as to be opposed to each other in the sheet feeding direction B. The two rack gears 54 extend in the vertical direction, and lower end portions thereof are respectively fixed to side faces of the frame 4. Further, a side face of each of the rack gears 54 which is opposite to a corresponding one of the pinion gears 53 slidably contacts with a corresponding one of the guides 56. The guides 56 are respectively fixed to the main body frames 1d.

In this configuration, when the two drive motors 52 are synchronized with each other, and the pinion gears 53 are forwardly or reversely rotated, the rack gear 54 are moved upward or downward. In accordance with the upward or downward movement of the rack gears 54, the frame 4 and the four ink-jet heads 2 are moved in the vertical direction.

Further, guide portions 59 are disposed on opposite sides of the ink-jet heads 2 in the longitudinal direction thereof. Each of the guide portions 59 is constituted by a rod member 58 and a pair of guides 57 nipping the rod member 58 therebetween. As shown in FIG. 3, the pair of guides 57 extend in the vertical direction and are respectively fixed to main body frames 1e opposed to each other in a direction perpendicular to the sheet feeding direction B. On the other hand, the rod members 58 extend in the vertical direction like the guides 57 and respectively fixed to side faces of the frame 4 which are disposed parallel and opposite to respective side faces of the main body frames 1e. Further, the rod member 58 is slidably nipped by the pair of guides 57. These guide portions 59 can prevent that the ink-ejection surfaces 3a of the respective ink-jet heads 2 are inclined relative to the outer peripheral surface 8a when the frame 4 is moved in the vertical direction by the frame moving mechanism 51.

The frame 4 is normally disposed at a “print position” (i.e., a position indicated in FIG. 3) at which the inks are ejected to the sheet to perform recording. In a maintenance operation of the ink-jet heads 2 (for example, in a purging operation in which the inks are forced to be ejected from the respective ink-jet heads 2, in a wiping operation for wiping the inks adhering to the ink-ejection surfaces 3a, and in a capping operation for covering or capping the ink-ejection surfaces 3a with the respective caps), the four ink-jet heads 2 are moved by the frame moving mechanisms 51, thereby being disposed at a “head maintenance position” located higher than the print position.

The ink-jet heads 2 are respectively connected to ink tanks 49 in the ink tank unit 1c installed in the space C. In the four ink tanks 49, the respective inks ejected from the ink-jet heads 2 are stored. The inks are respectively supplied to the ink-jet heads 2 from the ink tanks 49 via tubes or the like, not shown. The tubes are disposed along an inner face of the body 1a from the respective ink tanks 49. In a path to the ink-jet heads 2 located above, there are disposed sub-tanks which temporarily store the respective inks and pumps which respectively push up the inks to the sub-tanks.

There will be next explained in detail the maintenance unit 70 for performing the maintenance operation of the ink-jet heads 2. As shown in FIGS. 2 and 3, the maintenance unit 70 for performing the maintenance operation of the ink-jet heads 2 is disposed in the ink-jet printer 1 on a left side of the ink-jet heads 2 in FIG. 2. The maintenance unit 70 includes trays 71, 75 movable horizontally. The tray 71 has a generally square box-like shape having an opening opened upward and can enclose the tray 75. The tray 71 and the tray 75 are connected to each other by engaging means which will be described below so as to be attached and detached. The trays 71, 75 are attached and detached in accordance with a content of the maintenance operation.

The tray 71 is open at a side face thereof opposite to the ink-jet heads 2, and when the trays 71, 75 are disengaged in the wiping operation, for example, only the tray 71 is movable with the tray 75 remaining at its original position. Further, regardless of an engagement state of the engaging means, when the maintenance unit 70 is horizontally moved in a manner described below, the frame 4 is moved upward to the head maintenance position located higher than the print position (i.e., in a direction indicated by arrow C in FIG. 3), so that a space for the maintenance unit 70 is assured between the four ink-ejection surfaces 3a and the outer peripheral surface 8a. Then, the maintenance unit 70 is horizontally moved in a direction indicated by arrow D in FIG. 3.

A waste-ink receiving tray 77 is disposed just below the maintenance unit 70. This waste-ink receiving tray 77 has a size enclosing the tray 71 in plan view. Even when the tray 71 is moved to an right end of the ink-jet printer 1 in FIG. 2, the waste-ink receiving tray 77 overlaps with one of opposite end portions of the tray 71, which one is located on a side opposite to the ink-jet heads 2. An ink-discharge hole (i.e., a liquid-discharge hole) 77a is vertically formed through one of opposite end portions of the waste-ink receiving tray 77 which one is nearer to the ink-jet heads 2. The ink-discharge hole 77a guides or discharges, to a waste-ink accumulating portion (not shown), the inks flown onto the waste-ink receiving tray 77.

A wiper 72 and the tray 75 are disposed in the tray 71 with the wiper 72 located nearer to the ink-jet heads 2 than the tray 75. The wiper 72 is formed of an elastic material and is for wiping the ink-ejection surfaces 3a in the wiping operation. The wiper is disposed so as to extend in a direction parallel to the sheet feeding direction B. As shown in FIG. 2, in the tray 75, the four caps 76 each having a rectangular shape in plan view are arranged side by side in correspondence with the respective ink-ejection surfaces 3a of the ink-jet heads 2. The longitudinal direction (the main scanning direction) of the caps 76 is made parallel to a longitudinal direction of the ink-jet heads 2. The caps 76 are disposed in the sheet feeding direction B with pitches which are the same as pitches with which the ink-jet heads 2 are disposed in the sheet feeding direction B. The tray 75 and these caps 76 constitute a head cap unit.

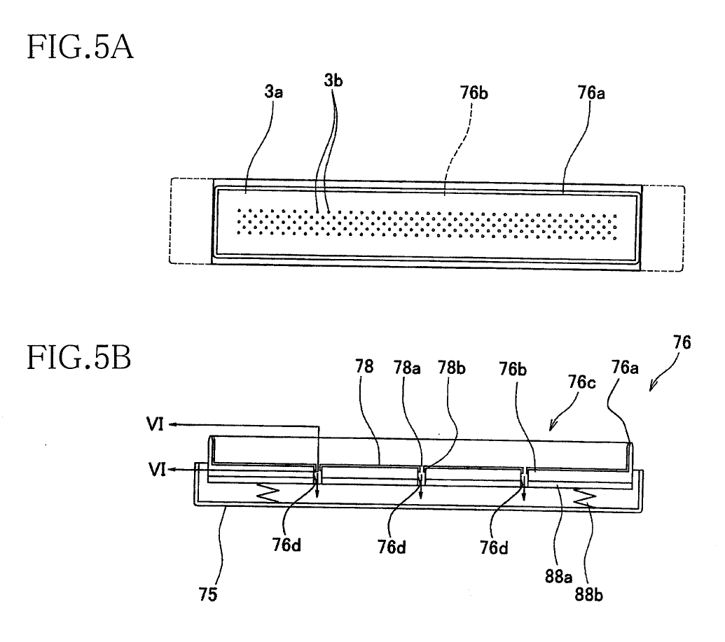

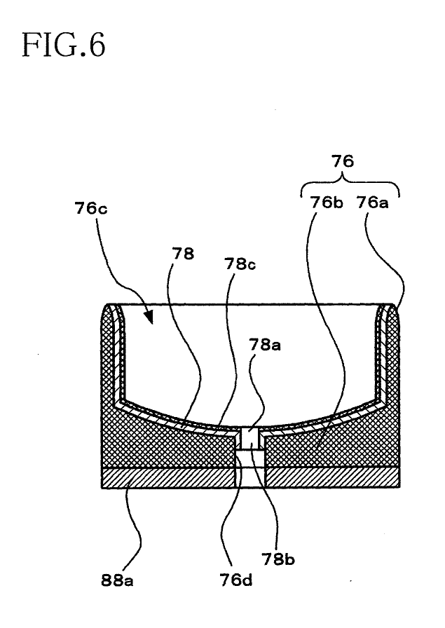

There will be explained the caps 76 with further reference to FIGS. 5A, 5B and 6. As shown in FIGS. 5A and 5B, each of the caps 76 includes (a) a circular projection 76a and having a generally rectangular shape projecting upward and (b) a bottom plate portion 76b having an outer peripheral end portion to which a basal end portion of the circular projection 76a is connected (i.e., from which the circular projection 76a extends) and having a generally rectangular shape extending in one direction. The circular projection 76a and the bottom plate portion 76b are each formed of an elastic material such as a rubber and a resin, and integrally define a recessed portion 76c opening upward. The cap 76 defining the recessed portion 76c seals the nozzles 3b when a distal end of the circular projection 76a and a corresponding one of the ink-ejection surfaces 3a contact with each other by the capping operation which will be described below. Further, at a center of the bottom plate portion 76b in a widthwise direction thereof, three ink-discharge holes 76d are formed through the bottom plate portion 76b and arranged in a longitudinal direction of the bottom plate portion 76b. As shown in FIG. 6, a bottom surface of the recessed portion 76c is curved in an inverted convex shape extending downward in the widthwise direction (the sub-scanning direction) of the bottom plate portion 76b such that openings of the respective ink-discharge holes 76d are located at respective lowermost positions of the bottom surface of the recessed portion 76c.

Further, as shown in FIGS. 5A, 5B, and 6, each cap 76 includes a stainless ink guiding plate 78 covering an inner wall surface of the circular projection 76a as a projecting portion and the bottom surface. The ink guiding plate 78 is formed by one stainless thin plate by press working. In other words, the ink guiding plate 78 is formed in one piece by means of a one-piece forming technique. A height of an edged portion of the ink guiding plate 78 from the bottom surface of the recessed portion 76c (i.e., a bottom surface of the bottom plate portion 76b which faces the ink-ejection surface 3a) is made the same as that of a distal end of the circular projection 76a from the bottom surface of the recessed portion 76c. As a result, the ink guiding plate 78 supports, as a side wall, an inner wall surface of the circular projection 76a. Further, in the capping operation, since the edged portion of the ink guiding plate 78 does not contact with the ink-ejection surface 3a before the circular projection 76a, thereby preventing that the ink-ejection surface 3a is damaged by contact of only the edged portion of the ink guiding plate 78 with the ink-ejection surface 3a. A front surface of the ink guiding plate 78 which is opposite to the inner wall surface of the recessed portion 76c (hereinafter, which front surface may be simply referred to as a “front surface” and a surface opposite to the front surface may be referred to as a “back surface”) is a mirror-finished surface having a surface roughness Rz of 0.1 i m. Further, on the front surface of the ink guiding plate 78 is formed a liquid-repellent layer 78c. That is, the liquid-repellent layer 78c is formed on the mirror-finished surface as the front surface. It is noted that the front surface of the ink guiding plate 78 may be a mirror-finished surface having the surface roughness Rz of smaller than 0.1 i m.

Further, as shown in FIGS. 5A, 5B, and 6, in the ink guiding plate 78, there are formed three through holes 78a respectively opposed to the openings of the respective three ink-discharge holes 76d of the bottom plate portion 76b. On a portion of the back surface of the ink guiding plate 78 in which each through hole 78a is formed, there is formed a projection 78b having a tubular shape along an opening edge portion of the through hole 78a. The projection 78b is formed so as to project from the back surface in a direction from the front surface of the ink guiding plate 78 to the back surface thereof, and the through hole 78a extends through the projection 78b. These three projections 78b are respectively inserted into the ink-discharge holes 76d respectively opposed thereto, whereby the projections 78b and the ink-discharge holes 76d are respectively fitted to each other. As a result, the ink guiding plate 78 is fixed to the bottom plate portion 76b of the cap 76, and each through hole 78a of the ink guiding plate 78 and the corresponding ink-discharge hole 76d of the bottom plate portion 76b are communicated with each other. To the ink-discharge hole 76d is connected a sucking pump (not shown) via a sucking tube (not shown). When the sucking pump is driven, the ink discharged to the ink guiding plate 78 is discharged to an outside via the through hole 78a and the ink-discharge hole 76d.

As shown in FIG. 6, an area of the ink guiding plate 78 which covers the bottom plate portion 76b is curved in an inverted convex shape extending downward along the bottom surface of the recessed portion 76c in a widthwise direction thereof such that the three through holes 78a are located at respective lowermost positions of the bottom surface of the recessed portion 76c. That is, the area of the ink guiding plate 78 which covers the bottom plate portion 76b is inclined downward toward the through holes 78a. As thus described, the front surface of the ink guiding plate 78 is the mirror-finished surface, the liquid-repellent layer 78c is formed, and the area of the ink guiding plate 78 which covers the bottom plate portion 76b is inclined downward toward the through holes 78a, so that the ink accumulated on the front surface of the ink guiding plate 78 is efficiently guided to the through holes 78a.

It is noted that, as shown in FIG. 6, the liquid-repellent layer 78c is not formed on inner walls of the respective through holes 78a. That is, the stainless front surfaces of the inner walls of the respective through holes 78a are given the mirror finish. From the viewpoint that ink droplets are certainly moved or flowed from positions nearer to the through holes 78a (the bottom surface of the recessed portion 76c) into the ink-discharge holes 76d, in the present embodiment, inner wall surfaces of the respective through holes 78a are each formed of a stainless material to be more hydrophilic (having a relatively high affinity for water) compared to the liquid-repellent layer 78c, thereby facilitating the ink droplets flowing into the through holes 78a.

The bottom plate portion 76b is supported from below by a base plate 88a having the same planar shape as the bottom plate portion 76b. The base plate 88a is supported by the tray 75 via two springs (elastic materials) 88b and biased upward. Thus, the springs 88b reduce an impact force generated when the circular projection 76a and the ink-ejection surfaces 3a contact with each other. Further, even where a degree of parallelization of the circular projection 76a to the ink-ejection surface 3a has an error to a certain extent, it becomes possible that the circular projection 76a follows an inclination relative to the ink-ejection surface 3a.

As shown in FIGS. 2 and 3 again, a holding member 74 holding the wiper 72 is fixed to a portion of the tray 71 which is nearer to the ink-jet heads 2. The holding member 74 has a U-shape in its plan view, and the wiper 72 is held at a portion of the holding member 74 which extends in the sheet feeding direction B. On the other hand, recessed portions 74a partly constituting the engaging means are respectively formed on end parts of respective portions of the holding member 74 which portions extend in the direction perpendicular to the sheet feeding direction B.

As described above, the tray 71 and the tray 75 are engaged with each other by the engaging means so as to be attachable and detachable. The engaging means are respectively disposed near upper and lower ends of the trays 71, 75 in FIG. 2 and each mainly constituted by the recessed portion 74a formed in the holding member 74 and a hook member 83 supported by the tray 75. The hook member 83 extends in the direction perpendicular to the sheet feeding direction B, and is pivotably supported at a central portion thereof. A hook portion 83a which engages the recessed portion 74a is formed on one of opposite end portions of the hook member 83 nearer to the ink-jet heads 2. Above the maintenance unit 70, there is pivotably supported a contact member 84 that can contact with an end portion 83b of each hook member 83 which is located furthest from the ink-jet heads 2. When each contact member 84 is pivoted to contact with the end portion 83b, the hook portion 83a and the recessed portion 74a are disengaged from each other. On the other hand, when the contact member 84 is moved away from the end portion 83b, the hook portion 83a is engaged with the recessed portion 74a and returns to a state shown in FIG. 3.

When the maintenance operation of the ink-jet heads 2 which will be described below is not performed, the maintenance unit 70 is, as shown in FIG. 3, at rest at a “retracted position” distant from the ink-jet heads 2 (i.e., a left position in FIG. 2 at which the maintenance unit 70 does not face the ink-jet heads 2). When the maintenance operation is performed, the maintenance unit 70 is horizontally moved from the retracted position to a “maintenance position” at which the maintenance unit 70 faces the ejection surfaces 3a of the respective ink-jet heads 2. In this movement, distal ends of the wiper 72 and the circular projection 76a are not brought into contact with the ejection surfaces 3a because the ink-jet heads 2 are disposed at the head maintenance position.

It is noted that even when the maintenance operation is performed, only the tray 71 is moved, in the wiping operation, from the retracted position to a position under the ink-jet heads 2 to receive the inks wiped by the wiper 72, with the tray 75 remaining at its original position. When the ejection surfaces 3a are covered by the respective caps 76 in a stand-by state of the ink-jet printer 1 and in the purging operation, the tray 71 and the tray 75 are connected to each other by the engaging means and moved to the maintenance position.

As shown in FIG. 2, the trays 71, 75 are movably supported by a pair of guide shafts 96a, 96b extending in the direction perpendicular to the sheet feeding direction B. Two bearing members 97a, 97b are provided on the tray 71. The bearing members 97a, 97b are projected from respective upper and lower side faces of the holding member 74. Two bearing members 98a, 98b are provided on the tray 75. The bearing members 98a, 98b are projected from the respective upper and lower side faces of the tray 75. The pair of guide shafts 96a, 96b are respectively fixed, at opposite ends thereof, to the main body frame 1e and a main body frame 1g, and disposed so as to be parallel to each other between the main body frames 1e, 1g. Here, the pair of guide shafts 96a, 96b are fixed by screws. In this configuration, each of the trays 71, 75 is moved along the guide shafts 96a, 96b in a right and left direction in FIG. 2 (indicated by arrow D).

Here, there will be explained a horizontally moving mechanism 91 for horizontally moving the trays 71, 75. As shown in FIG. 2, the horizontally moving mechanism 91 includes a motor 92, a motor pulley 93, an idle pulley 94, a timing belt 95, the guide shafts 96a, 96b, and so on. The motor 92 is fixed by, e.g., screws to a mount portion 1f formed at one of end portions of the main body frame 1e extending in the direction parallel to the sheet feeding direction B. The motor pulley 93 is connected to the motor 92, and rotated in accordance with driving of the motor 92. The idle pulley 94 is rotatably supported by the main body frame 1g located at the most left side of the ink-jet printer 1 in FIG. 2. The timing belt 95 is disposed so as to be parallel to the guide shaft 96a and wound around the motor pulley 93 and the idle pulley 94 as a pair to bridge the motor pulley 93 and the idle pulley 94. The timing belt 95 is connected to the bearing member 97a provided on the holding member 74.

In this construction, when the motor 92 is driven, the timing belt 95 is rotated in accordance with a forward or a reverse rotation of the motor pulley 93. By the rotation of the timing belt 95, the tray 71 connected to the timing belt 95 via the bearing member 97a is moved leftward or rightward in FIG. 2, that is, in a direction toward the retracted position or the maintenance position. It is noted that in a state in which the recessed portion 74a of the holding member 74 and the hook portion 83a are engaged with each other, the wiper 72 in the tray 71 and the caps 76 in the tray 75 are moved together with each other. On the other hand, in a state in which the hook portion 83a and the recessed portions 74b are not engaged with each other, only the wiper 72 in the tray 71 is moved.

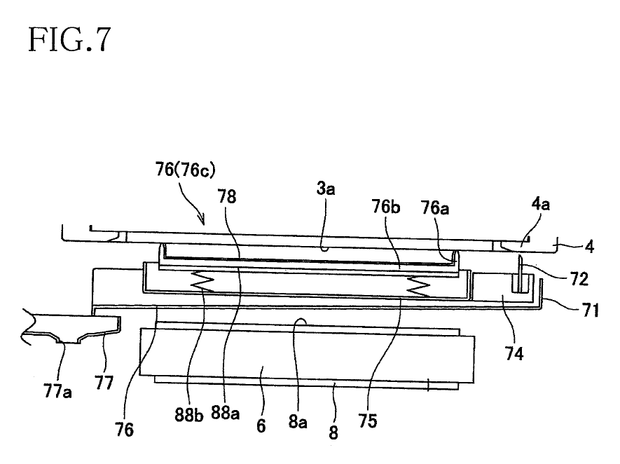

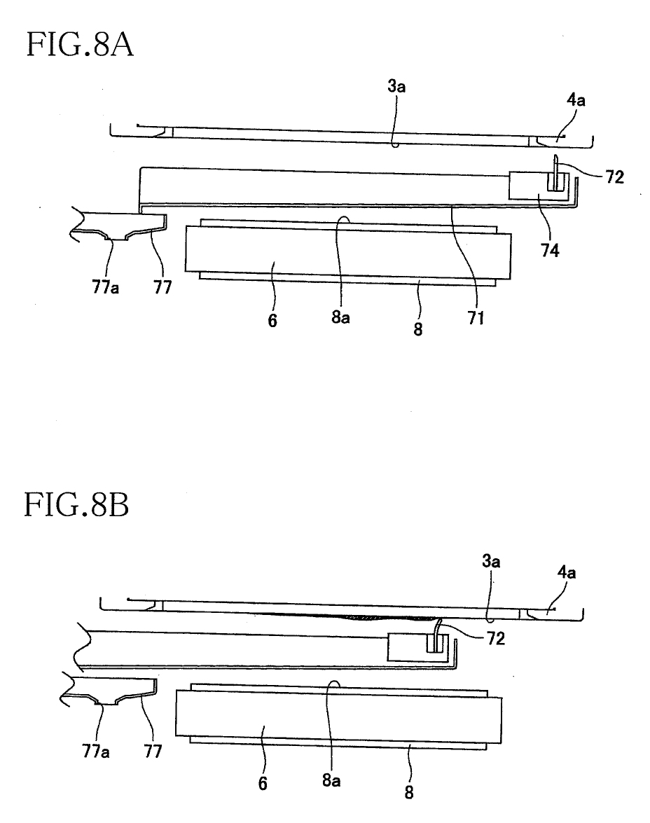

There will be next explained an operation of the maintenance unit 70 with reference to FIGS. 7, 8A, and 8B.

When performing the purging operation for recovering the ink-jet heads 2 in which ink ejection failure occurs, initially the capping operation in which the caps 76 respectively seal or closely contact with the ink-ejection surfaces 3a is performed. The frame 4 is moved upward by the frame moving mechanisms 51, whereby the ink-jet heads 2 are positioned at the head maintenance position. As a result, the space in which the maintenance unit 70 can be disposed is formed between the ink-ejection surfaces 3a and the sheet-feed belt 8. The ink-ejection surfaces 3a of the respective ink-jet heads 2 located at the head maintenance position are located at a position in which the ink-ejection surfaces 3a are not brought into contact with the distal ends of the wiper 72 and the circular projection 76a when the maintenance unit 70 is moved to the maintenance position.

Then, as shown in FIG. 7, the tray 71 and the tray 75 are moved from the retracted position to the maintenance position by the horizontally moving mechanism 91 in a state in which the tray 71 and the tray 75 are connected to each other by the hook member 83. In this time, the recessed portion 76c of each cap 76 is disposed at a position facing a surrounding of an area in which the corresponding nozzles 3b are formed. Further, the ink-jet heads 2 are moved downward by the frame moving mechanisms 51, whereby the circular projection 76a is brought into contact with the ink-ejection surface 3a. As thus described, the ink-ejection surface 3a is covered with the recessed portion 76c of the cap 76 to be sealed, and the capping operation is completed. This operation prevents drying of the nozzles 3b in the stand-by state of the ink-jet printer 1.

Next, when performing the purging operation, in this state, the pump, not shown, forcing the ink in each ink tank 49 to feed to the corresponding ink-jet head 2 is driven, and the purging operation is performed in which the ink is ejected from the nozzles 3b of the ink-jet head 2 into the cap 76. This purging operation resolves clogging of the nozzles 3b of the ink-jet head 2 in which the ink ejection failure occurs, and thickening of the ink in the nozzles 3b. Further, since the liquid-repellent layer 78c is formed on the front surface of the ink guiding plate 78 being the mirror-finished surface, and the area of the ink guiding plate 78 which covers the bottom plate portion 76b is inclined downward toward each through hole 78a, the ink ejected into the cap 76 is efficiently guided to the through hole 78a. Further, by driving the sucking pump, not shown, the ink guided to the through hole 78a is discharged to the outside via the through hole 78a and the ink-discharge hole 76d. A part of the ink, however, remains on the ink-ejection surface 3a as ink droplets.

Next, in order to perform the wiping operation, the frame 4 is moved upward again by the frame moving mechanisms 51, thereby disposing the ink-jet heads 2 at the head maintenance position. Then, the tray 71 and the tray 75 are moved from the maintenance position to the retracted position by the horizontally moving mechanism 91. Then, the hook portion 83a is moved away from the recessed portion 74a by contacting the contact member 84 with the end portion 83b of the hook member 83, whereby the recessed portion 74a and the hook portion 83a are disengaged from each other. That is, the connection of the tray 71 and the tray 75 is released. In this state, as shown in FIG. 8A, the tray 71 is moved from the retracted position to the maintenance position by the horizontally moving mechanism 91.

Next, the ink-jet heads 2 are moved downward by the frame moving mechanisms 51. In this time, when the tray 71 is moved leftward in FIG. 7 (that is, in a direction from the maintenance position toward the retracted position), the ink-jet heads 2 are disposed at a position at which the distal end of the wiper 72 can contact with the ink-ejection surfaces 3a. Then, as shown in FIG. 8B, the tray 71 is moved from the maintenance position to the retracted position by the horizontally moving mechanism 91.

In this wiping operation, since an upper end of the wiper 72 is located above the ink-ejection surfaces 3a, the wiper 72 contacts with the ink-ejection surfaces 3a while bending, thereby wiping the inks adhering to the ink-ejection surfaces 3a by the purging operation. The inks wiped by the wiper 72 are transferred on a surface of the wiper 72 and then flowed into the waste-ink receiving tray 77. Then, the inks are discharged from the ink-discharge hole 77a of the waste-ink receiving tray 77.

As thus described, the maintenance operation is completed in which the ink-jet heads 2 being subjected to the ink ejection failure are recovered by the capping operation and the purging operation, and the inks adhering to the respective ink-ejection surfaces 3a are wiped by the wiping operation.

According to the ink-jet printer 1 as the above-described present embodiment, since each stainless ink guiding plate 78 covers the inner wall surface of the respective circular projections 76a, there can be prevented that each circular projection 76a falls to an inside of the cap 76 when the circular projection 76a is brought into contact with the corresponding ink-ejection surface 3a. As a result, it is restrained that airtightness in the cap 76 lowers. Further, since the stainless material is stable with respect to the ink, there can be prevented deterioration of the ink accumulated on the ink guiding plate 78. Further, since the front surface of the ink guiding plate 78 is the mirror-finished surface, the inks accumulated on the front surface of the ink guiding plate 78 can be easily discharged.

Further, since the liquid-repellent layer 78c is formed on the front surface of the ink guiding plate 78, the ink accumulated on the front surface of the ink guiding plate 78 can be discharged more easily.

Further, since the ink-discharge holes 76d through which the ink is discharged are formed in the bottom plate portion 76b, and the through holes 78a are formed in the ink guiding plate 78 at the positions thereof respectively opposed to the ink-discharge holes 76d, the ink accumulated on the ink guiding plate 78 can be efficiently discharged to the outside via the through holes 78a and the ink-discharge holes 76d.

In this time, since the area of the ink guiding plate 78 which covers the bottom plate portion 76b is inclined downward toward the through holes 78a, the ink accumulated on the ink guiding plate 78 can be more efficiently discharged to the outside via the through holes 78a and the ink-discharge holes 76d.

Further, the ink guiding plate 78 is formed or molded by one stainless thin plate. This leads to a lower cost of the cap 76.

The ink guiding plate 78 is easily fitted to the bottom plate portion 76b of the cap 76 by fitting of the projections 78b of the ink guiding plate 78 into the respective ink-discharge holes 76d of the bottom plate portion 76b. This also leads to the lower cost of the cap 76.

The height of the edged portion of the ink guiding plate 78 from the bottom surface of the recessed portion 76c of the cap 76 is the same as that of the distal end of the circular projection 76a from the bottom surface. As a result, there can be prevented that the ink-ejection surface 3a is damaged by the contact of only the edged portion of the ink guiding plate 78 with the ink-ejection surface 3a before the contact of the circular projection 76a and the ink-ejection surface 3a.

It is to be understood that the present invention is not limited to the details of the illustrated embodiment, but may be embodied with various changes and modifications, which may occur to those skilled in the art, without departing from the spirit and scope of the present invention. For example, in the above-described embodiment, the liquid-repellent layer 78c is formed on the front surface of the ink guiding plate 78, but the liquid-repellent layer 78c may not be formed on the front surface of the ink guiding plate 78. Further, in the above-described embodiment, the ink guiding plate 78 is configured to cover the inner wall surface of the circular projection 76a and the bottom plate portion 76b, but may be configured to cover only the inner wall surface of the circular projection 76a in order to prevent the circular projection 76a from falling or tipping. In this case, the ink guiding plate 78 functions as an inner plate which prevents the circular projection 76a from falling.

Further, in the above-described embodiment, the ink accumulated on the ink guiding plate 78 is discharged to the outside via the through holes 78a and the ink-discharge holes 76d, but the through holes 78a and the ink-discharge holes 76d may not be formed. In this configuration, each ink-jet head 2 preferably ejects the ink directly to the tray 71 in the purging operation.

Further, in the above-described embodiment, the area of the ink guiding plate 78 which covers the bottom plate portion 76b is inclined downward toward the through holes 78a, but may not be inclined.

In addition, in the above-described embodiment, the projections 78b of the ink guiding plate 78 are respectively fitted into the ink-discharge holes 76d of the bottom plate portion 76b, whereby the ink guiding plate 78 is fixed to the bottom plate portion 76b of the cap 76, but may be fixed by another method such as adhesive.

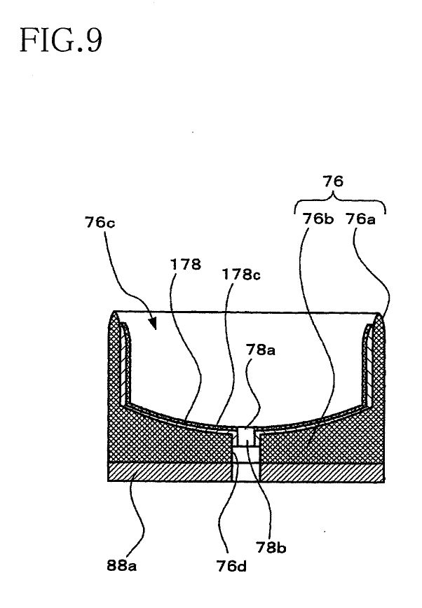

Further, in the above-described embodiment, the height of the edged portion of the ink guiding plate 78 from the bottom surface of the recessed portion 76c of the cap 76 (i.e., the height between the edged portion and the bottom surface) is the same as that of the distal end of the circular projection 76a from the bottom surface (i.e., the height between the distal end and the bottom surface), but, from the viewpoint of preventing the damage of the ink-ejection surface 3a, as shown in FIG. 9, a height of an edged portion of an ink guiding plate 178 from the bottom surface is preferably smaller than that of the distal end of the circular projection 76a from the bottom surface of the recessed portion 76c. According to this configuration, even where the cap 76 is inclined relative to the ink-ejection surface 3a, only the distal end of the circular projection 76a which is exposed from the ink guiding plate 178 certainly contacts with the ink-ejection surface 3a.

Further, in the above-described embodiment, the present invention is applied to the ink-jet printer 1, and the head cap unit constituted by the tray 75 and the four caps 76 is incorporated into the maintenance unit 70, but only the head cap unit may be independent. In this case, the head cap unit may have one, two, three, or more than or equal to five cap(s) 76.

What is claimed is:

1. A head cap, comprising:
a bottom plate portion having a bottom surface facing a liquid-droplets ejecting surface of a liquid-droplets ejecting head;
a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area; and
an inner plate which is disposed along the projecting portion so as to cover an inner wall surface of the projecting portion.

2. The head cap according to claim 1,
wherein the inner plate is formed of a stainless material.

3. The head cap according to claim 1,
wherein the inner plate is a liquid guiding plate which covers the inner wall surface of the projecting portion and the bottom surface.

4. The head cap according to claim 3,
wherein a surface of the liquid guiding plate which is opposite to the bottom surface is a mirror-finished surface.

5. The head cap according to claim 4,
wherein a liquid-repellent layer is formed on the surface of the liquid guiding plate.

6. The head cap according to claim 5,
wherein a liquid-discharge hole through which a liquid is discharged is formed in the bottom plate portion; and
wherein a through hole is formed through the liquid guiding plate at a position opposed to the ink-discharged hole.

7. The head cap according to claim 6,
wherein an area of the surface of the liquid guiding plate which covers the bottom surface is inclined downward toward the through hole.

8. The head cap according to claim 3,
wherein the liquid guiding plate is formed by one-piece forming.

9. The head cap according to claim 6,
wherein the liquid guiding plate includes a projection which projects from the liquid guiding plate, and
wherein the through hole is formed through the projection.

10. The head cap according to claim 9,
wherein the liquid guiding plate is fixed to the bottom plate portion by fitting of the projection into the liquid-discharge hole of the bottom plate portion.

11. The head cap according to claim 9,
wherein the projection is formed to have a tubular shape along an opening edge portion of the liquid-discharge hole.

12. The head cap according to claim 6,
wherein the liquid-repellent layer is not formed on an inner wall of the through hole.

13. The head cap according to claim 3,
wherein a height of an edged portion of the liquid guiding plate from the bottom surface is equal to or smaller than that of the projecting portion from the bottom surface.

14. The head cap according to claim 4,
wherein the surface of the liquid guiding plate is the mirror-finished surface having a surface roughness of equal to or smaller than 0.1 i m.

15. An image recording apparatus, comprising:
a liquid-droplets ejecting head including a liquid-droplets ejecting surface in which a liquid-droplets ejecting area is formed; and
a head cap including (a) a bottom plate portion having a bottom surface facing the liquid-droplets ejecting surface of the liquid-droplets ejecting head and (b) a projecting portion which functions as a side wall, which extends from the bottom plate portion so as to define a recessed portion with the bottom plate portion, and whose distal end contacts with a surrounding of the liquid-droplets ejecting area formed in the liquid-droplets ejecting surface so as to enclose the liquid-droplets ejecting area,
wherein the head cap further includes an inner plate which is disposed along the projecting portion so as to cover an inner wall surface of the projecting portion.
